(19) United States
(12) Patent Application Publication
(10) Pub. No.: US 2026/0180696 A1
(43) Pub. Date: Jun. 25, 2026

(54) RADIO FREQUENCY LANDSCAPE MAP

(71) Applicant: Swift Beat, LLC, Menlo Park, CA (US)

(72) Inventors: David BOTTON, Fort Lauderdale, FL (US); Alexander Mezhirov, Lexington, MA (US)

(21) Appl. No.: 19/452,194

(22) Filed: Jan. 16, 2026

Related U.S. Application Data
(63) Continuation-in-part of application No. 19/426,040, filed on Dec. 18, 2025.
(60) Provisional application No. 63/737,568, filed on Dec. 20, 2024.
(60) Provisional application No. 63/746,895, filed on Jan. 17, 2025.
(60) Provisional application No. 63/750,068, filed on Jan. 27, 2025.
(60) Provisional application No. 63/893,387, filed on Oct. 3, 2025.

(51) Int. Cl. H04B 17/27; G01C 21/34; G01S 5/02; H04B 17/318; H04B 17/391; H04W 64/00

(52) U.S. Cl. CPC H04B 17/27; G01C 21/3461; G01S 5/02521; H04B 17/391; H04W 64/006; H04B 17/318

(57) ABSTRACT

A system includes at least one processor, and a memory that includes computer program code. The memory and the computer program code are configured to, with the at least one processor, cause the at least one processor to monitor a radio frequency (RF) spectrum within an area to detect RF emissions from RF emitters, acquire emission data of the detected RF emissions, process the acquired emission data to determine approximate locations of the RF emitters, and compile the determined approximate locations and acquired emission data into an RF landscape map of the area.

### CROSS-REFERENCE TO RELATED APPLICATIONS

This non-provisional utility application claims priority to provisional patent application No. 63/746,895, entitled “RADIO FREQUENCY LANDSCAPE MAP” and filed on Jan. 17, 2025, provisional patent application No. 63/893,387, entitled “RADIO FREQUENCY DETECTION” and filed on Oct. 3, 2025, provisional patent application No. 63/750,068, entitled “DYNAMIC NAVIGATION SYSTEM AND METHOD” and filed on Jan. 27, 2025, each of which is incorporated herein in its entirety by reference.

### BACKGROUND

Known navigation systems include a variety of methods including global positioning systems (GPS), inertial navigation systems (INS), and terrain-referenced navigation (TRN). However, known navigation systems suffer from a variety of limitations.

### SUMMARY

In one aspect, a system includes at least one processor, and a memory that includes computer program code. The memory and the computer program code are configured to, with the at least one processor, cause the at least one processor to monitor a radio frequency (RF) spectrum within an area to detect RF emissions from RF emitters, acquire emission data of the detected RF emissions, process the acquired emission data to determine approximate locations of the RF emitters, and compile the determined approximate locations and acquired emission data into an RF landscape map of the area.

In another aspect, a method includes monitoring a radio frequency (RF) spectrum within an area to detect RF emissions from RF emitters, acquiring emission data of the detected RF emissions, processing the acquired emission data to determine approximate locations of the RF emitters, and compiling the determined approximate locations and acquired emission data into an RF landscape map of the area.

In another aspect, a system includes at least one processor, and a memory that includes computer program code. The memory and the computer program code are configured to, with the at least one processor, cause the at least one processor to access a radio frequency (RF) landscape map that comprises approximate locations and emission data of RF emitters, define a navigation path utilizing the approximate locations and the emission data of at least some of the RF emitters of the RF landscape map, and deploy a mobile platform to follow the navigation path.

### BRIEF DESCRIPTION OF THE DRAWINGS

FIG. 1 is a schematic diagram illustrating a radio frequency (RF) landscape navigation system according to an implementation.

FIG. 2 is a schematic diagram illustrating an example of an RF landscape map according to an implementation.

FIG. 3 is a schematic diagram illustrating an example of a navigation path according to an implementation.

FIG. 4 is a schematic diagram illustrating another example of a navigation path according to an implementation.

FIG. 5 is a flowchart illustrating a method of operation of the RF landscape navigation system of FIG. 1 according to an implementation.

FIG. 6 is a flowchart illustrating a method of operation of the RF landscape navigation system of FIG. 1 according to an implementation.

FIG. 7 is a schematic diagram illustrating the RF landscape navigation system of FIG. 1 being deployed onboard a mobile platform according to an implementation.

FIG. 8 is a schematic diagram illustrating an exemplary operating environment of the disclosure according to an implementation.

### DETAILED DESCRIPTION

Known navigation systems include a variety of methods including global positioning systems (GPS), inertial navigation systems (INS), and terrain-referenced navigation (TRN). Known navigation systems incorporate satellite-based signals, sensors, and geographical maps as primary sources for navigating (e.g., determining location, direction, speed, etc.). However, known navigation systems suffer from limitations such as signal reliability and availability, particularly in environments where satellite signals may be obstructed and/or disrupted such as in relatively densely built urban areas and/or conflict zones. For example, GPS-based navigation is subject to signal degradation, for example from obstacles (e.g., physical obstructions) and atmospheric conditions. GPS is also susceptible to jamming, spoofing, and/or the like, for example in hostile environments. Moreover, GPS and other known navigation systems depend on satellite infrastructure, which constrains utility in areas lacking (e.g., without) coverage and/or areas where satellite signals are compromised (e.g., in disaster scenarios). In another example of the disadvantages of known navigation systems, INS may suffer from cumulative errors (e.g., drift) and therefore require periodic recalibration and/or updates (from an external source) to maintain accuracy. TRN systems depend on the availability of detailed map data and can face challenges in flat and/or featureless terrains.

In contrast, aspects of the disclosure provide navigation using radio frequency (RF) landscapes, for example with applications in areas where known navigation systems are less effective or ineffective. Aspects of the disclosure detect RF emissions from mobile, stationary, terrestrial, and/or airborne RF emitters to create a spatial map of the RF environment (an “RF landscape map”). In some aspects of the disclosure, the RF landscape map serves as a navigational guide for mobile platforms to navigate within an area. In one example, aspects of the disclosure involve an initial mapping of the RF environment, for example (but as described below not limited to) by following (e.g., flying, driving, etc.) one or more routes and gathering RF data along the route(s) to generate an RF landscape map. The route(s) may include a designated, predefined, and/or predetermined route. Subsequently, mobile platforms can use the generated RF landscape map to navigate through an area covered by the RF landscape map utilizing the mapped RF emitters as waypoints. In this example, the area has unreliable GPS signals.

Aspects of the disclosure are operable in any environment where RF emitters are present. The methods and systems disclosed herein are not limited to being applied to navigation, but rather may be additionally or alternatively implemented in a range of applications beyond navigation functions including, but not limited to, telecommunications, environmental and/or conservation applications, transportation, agriculture, logistics, emergency response, security, surveillance, and/or the like. For example, aspects of the disclosure generate and utilize detailed spatial and frequency information encoded within the RF landscape map, thereby providing new capabilities. The flexibility and robustness of the RF landscape navigation systems disclosed herein offer substantial benefits for commercial, environmental, and/or public safety sectors, for example providing reliable navigation alternatives.

An example implementation includes RF source identification and/or monitoring. For example, the RF landscape map assists in identifying and/or monitoring specific RF emitters within a defined area. By tracking any changes in signal characteristics over time, aspects of the disclosure can detect unauthorized and/or rogue transmissions, for example providing a tool for regulatory compliance, spectrum management, and/or the like. Example signal characteristics include frequency drift, strength fluctuations, and the like.

Environmental impact assessment is another example implementation. For example, using the RF landscape map, an analysis of RF exposure levels in relation to human health and safety standards can be conducted. By understanding the density and intensity of RF sources, the RF landscape map can be leveraged to ensure compliance with regulatory standards, evaluate potential environmental impacts in populated and/or sensitive ecological areas, and/or the like. These and other environmental monitoring and/or conservation efforts benefit from the RF landscape navigation systems disclosed herein, for example by enabling the tracking and/or data collection of wildlife and/or environmental changes such as in regions where GPS infrastructure is insufficient and/or disrupted.

In a telecommunications industry example, aspects of the disclosure provide mobile telecommunication network planning. For example, telecommunication providers can employ the RF landscape map to optimize the deployment of new infrastructure, improve existing network coverage, and/or the like. By overlaying emitter locations onto service area maps, aspects of the disclosure identify gaps in coverage and/or areas with excessive overlap, for example facilitating more effective resource allocation, network design, and/or the like.

Emergency response operations are another example implementation. For example, aspects of the disclosure establish an emergency communication system. In one example of a disaster scenario where traditional communication infrastructure has been degraded, the RF landscape map establishes a temporary communication network. For example, by using known RF sources as relay points and/or reference beacons, emergency communication channels can be quickly configured, for example ensuring continuous information flow in crisis situations. In another example, emergency response teams utilize the RF landscape navigation systems disclosed herein during search and rescue operations, for example in disaster-stricken environments where conventional navigation means may be unavailable.

An exemplary transportation industry implementation of aspects of the disclosure is routing delivery vehicles in urban logistics, facilitating relatively precise navigation amidst relatively dense infrastructure. Other example implementations include deployment of mobile platforms for reconnaissance and/or delivery of essential supplies to remote locations, for example by navigating using RF emitters as waypoints as disclosed herein.

In the agriculture industry, one exemplary implementation of aspects of the disclosure includes using mobile platforms equipped with the RF landscape navigation systems disclosed herein to assist in field mapping and/or monitoring, for example in areas with poor GPS reception. This can be to aid in precision agriculture practices to optimize resource management, crop yield, and/or the like.

In a logistics example, aspects of the disclosure provide asset tracking and/or management. For example, the RF landscape map provides a framework for developing systems to track and/or manage assets equipped with RF sensors. By utilizing the known positions of RF sources, assets can determine their location independently of satellite navigation systems, for example enabling tracking in environments where traditional tracking methods may fail.

Another example includes security and/or surveillance applications. For example, security operations can utilize the RF landscape map in critical infrastructure areas. By employing mobile platforms to continuously update the RF landscape map, real-time positional awareness of security personnel and/or assets can be maintained.

In another example, aspects of the disclosure provide electronic interference resolution and/or mitigation. The RF landscape map may be used to diagnose and/or resolve electronic interference issues, for example in RF-dependent systems. By pinpointing the sources and/or behavior of interfering signals, effective mitigation strategies can be developed, for example ensuring the integrity and/or reliability of communication and/or navigation services.

In some examples, aspects of the disclosure are used in the autonomous navigation of uncrewed aerial vehicles (UAVs) for applications such as, but not limited to, infrastructure inspection, wildlife monitoring, agricultural surveys, and/or the like. By using the RF landscape maps of aspects of the disclosure, UAVs can more effectively monitor specific elements within a complex, dense, and/or crowded signal environment.

Aspects of the disclosure operate in an unconventional manner at least by providing a system includes at least one processor, and a memory that includes computer program code. The memory and the computer program code are configured to, with the at least one processor, cause the at least one processor to monitor an RF spectrum within an area to detect RF emissions from RF emitters, acquire emission data of the detected RF emissions, process the acquired emission data to determine approximate locations of the RF emitters, and compile the determined approximate locations and acquired emission data into an RF landscape map of the area.

Aspects of the disclosure operate in an unconventional manner at least by providing a method that includes monitoring an RF spectrum within an area to detect RF emissions from RF emitters, acquiring emission data of the detected RF emissions, processing the acquired emission data to determine approximate locations of the RF emitters; and, compiling the determined approximate locations and acquired emission data into an RF landscape map of the area.

Aspects of the disclosure operate in an unconventional manner at least by providing a system that includes at least one processor, and a memory including computer program code. The memory and the computer program code are configured to, with the at least one processor, cause the at least one processor to access an RF landscape map that comprises approximate locations and emission data of RF emitters, define a navigation path utilizing the approximate locations and the emission data of at least some of the RF emitters of the RF landscape map, and deploy a mobile platform to follow the navigation path.

Example technical solutions to the technical problems described herein are provided by aspects of the disclosure utilizing RF landscapes for navigation. For example, aspects of the disclosure utilize mobile and/or stationary platforms to map the locations of RF emitters within an area. An RF landscape map of the area is generated from the mapped locations of the RF emitters. The RF landscape map may serve as a navigation tool, for example leveraging existing RF infrastructures. In some aspects of the disclosure, the RF landscape map provides the technical effect of enabling mobile platforms to navigate by identifying (e.g., targeting) mapped RF emitters and using the identified RF emitters as waypoints along a navigation path. Some aspects of the disclosure utilize the RF landscape map to identify one or more mapped RF emitters that are to be avoided and determine the technical effect of a navigation path that avoids the one or more identified RF emitters (e.g., a navigation path that can be followed by a mobile platform to avoid the one or more identified RF emitters, etc.). Example RF emitters to be avoided include those designated to be a potential threat, such as, but not limited to, a jamming emitter, and/or the like.

Aspects of the disclosure provide the technical solution of integrating non-RF data, for example providing the technical effect of augmenting navigation accuracy. Example non-RF data includes, but is not limited to, visual information, visual cues, environmental information, environmental variables, wind patterns, wind speed, wind direction, terrain features, video footage, temperatures, and/or any other sensor data.

In some examples, the disclosed methods and systems provide the technical effect of enabling navigation without reliance on traditional-satellite-based systems. Aspects of the disclosure find utility in civilian navigation, for example enhancing capabilities in environments where GPS signals are unreliable and/or unavailable. Such environments include, but are not limited to, densely built urban areas, areas with signal obstruction, remote regions, and/or regions with limited satellite coverage.

Aspects of the disclosure provide the technical solution of a more resilient, versatile navigation system capable of operation in GPS-denied environments and without dependence on continuous external updates and/or detailed map data. For example, aspects of the disclosure perform RF landscape mapping to provide the technical effect of a more robust navigation framework that is adaptable to diverse operational demands.

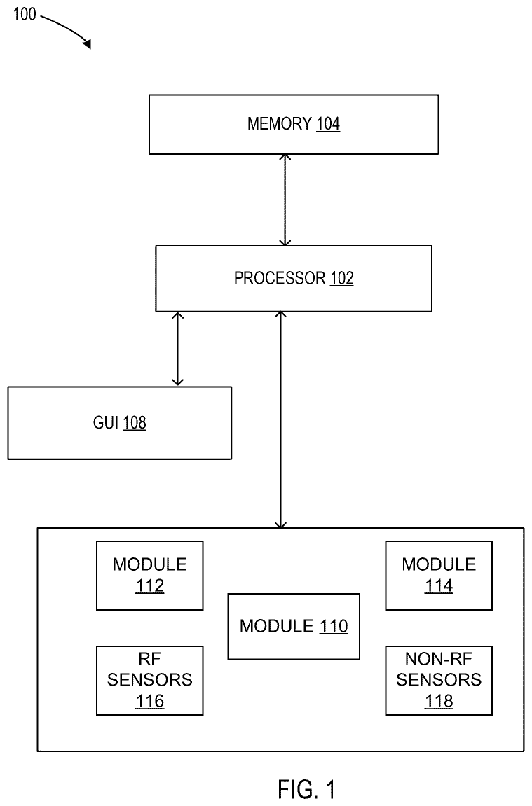

Referring to the figures, FIG. 1 is a block diagram illustrating an RF landscape navigation system 100 according to an implementation. In some examples, the system 100 includes a processor 102 and a memory 104 configured to store computer program code. The memory 104 and the computer program code are configured to, with the processor 102, cause the processor 102 to perform various operations, functions, and/or the like of the system 100. For example, the processor 102 may function as a central processing entity, managing operations and coordinating data flow between components. The memory 104 is connected to the processor 102 and stores instructions and data necessary for the execution of the various operations, functions, and/or the like of the system 100, such as functions and algorithms for generating an RF landscape map and/or navigating using an RF landscape map.

In some examples, one or more operations, functions, results, conclusions, calculations, determinations, generations, detections, and/or the like of the system 100 can be provided for display via a graphical user interface (GUI). The GUI includes a GUI 108 of the system 100, and/or a GUI of another system, computing device, electronic device, server, and/or the like. The GUI 108 is interfaced with the processor 102, enabling user interaction and visualization of data processed by the system 100, for example allowing for configuration changes and/or monitoring of the various operations, functions, and/or the like of the system 100.

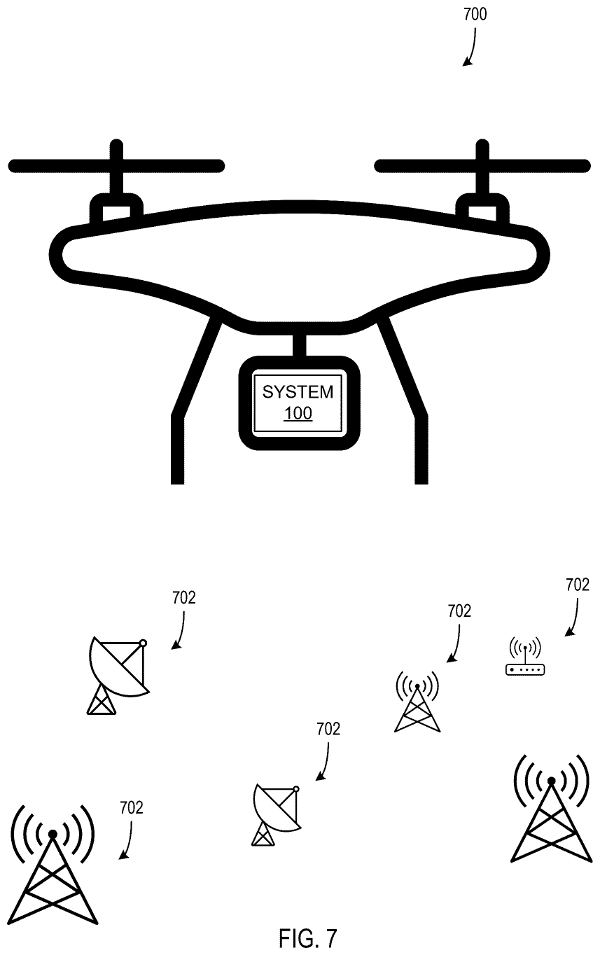

In some examples, the system 100 is configured for use onboard a platform, such as, but not limited to, a mobile platform (e.g., the mobile platform 700 shown in FIG. 7, etc.), a stationary platform, and/or the like. The system 100 may be used, for example, while the platform is within a range (e.g., signal receiving range, visual range, radar range, a distance range, etc.) of one or more potential emitters. In some examples, the systems and methods disclosed herein are used with (e.g., onboard, onboard control, remote from, remote control, etc.) one or more uncrewed, autonomous platforms.

Examples of mobile platforms include, but are not limited to, uncrewed vehicles, aircraft (e.g., rotorcraft, fixed wing aircraft, gliders, lighter-than-air craft, balloons, high-altitude balloons, UAVs, etc.), land vehicles, uncrewed ground vehicles (UGVs), marine vehicles, surface vehicles, submersibles, uncrewed marine vehicles (UMVs), uncrewed surface and/or submersible vehicles (USVs), space-based platforms (e.g., cubesats, etc.), suborbital vehicles, vehicles that operate in orbit, platforms carried by an individual (e.g., a backpack and/or other carrying pack, etc.), animals (e.g., a flying animal such as a bird and/or insect, a land animal, a marine animal, etc.), missiles, rockets, uncrewed mobile platforms, autonomous mobile platforms, and/or the like. As used herein, the system 100 may be used onboard a mobile platform while the mobile platform is moving and/or while the mobile platform is stationary.

Examples of stationary platforms include, but are not limited to, stations, arrays, central controls, centralized control stations, towers, cellular towers, fixed positions, fixed structures, stationary vehicles, uncrewed stationary platforms, autonomous stationary platforms, buildings, emplacements, installations, ground-based installations, forts, prisons, government locations, government buildings, stadiums, parks, public spaces, infrastructure, dams, public venues, private venues, concert venues, sporting venues, and/or the like.

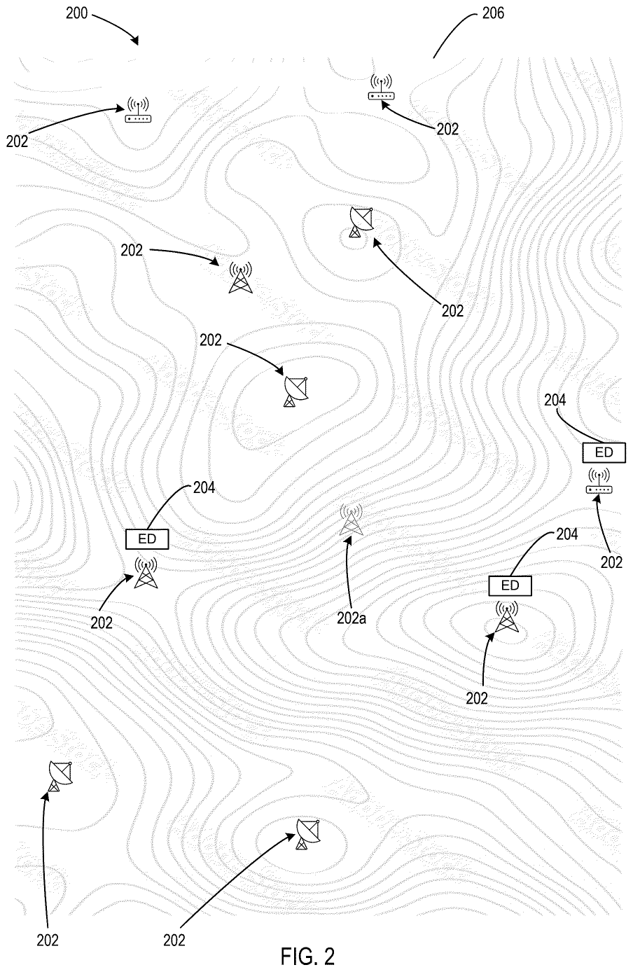

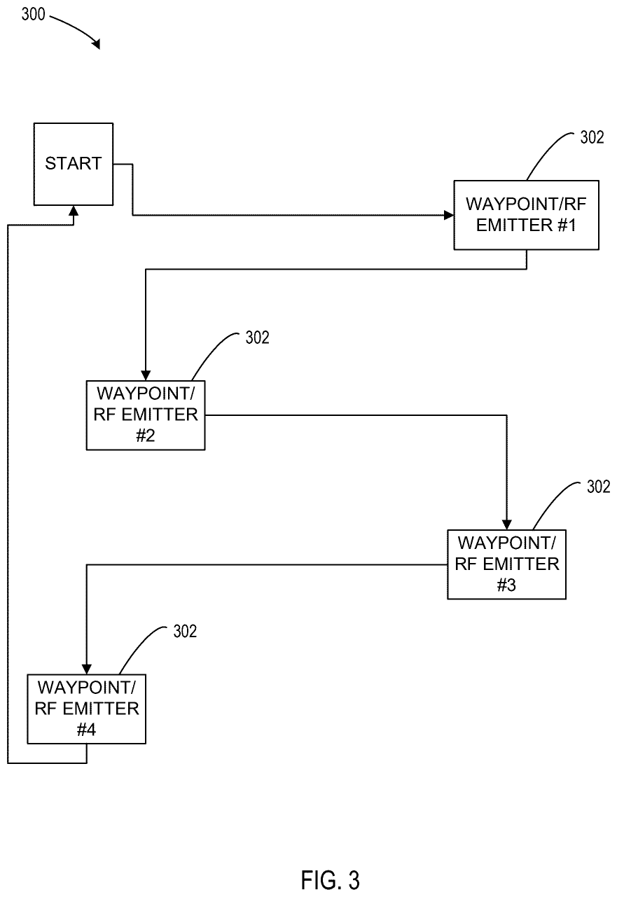

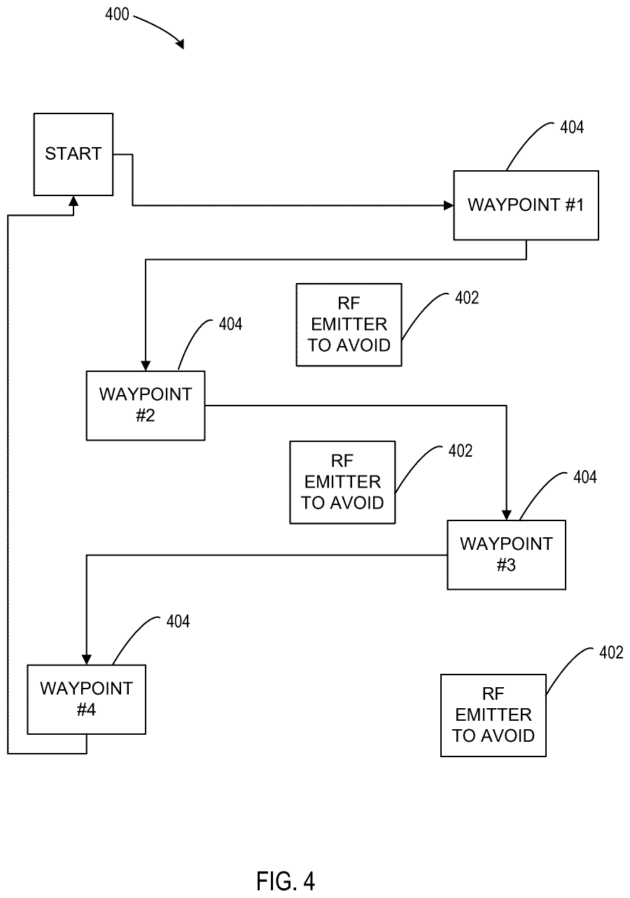

Although the RF sources and emitters disclosed herein may additionally or alternatively include any other type of emitter, source, and/or the like, in some examples, the RF emitters and/or sources disclosed herein (e.g., the RF emitters 202 shown in FIG. 2, the RF emitters 302 shown in FIG. 3, the RF emitters 402 shown in FIG. 4, the RF emitters 702 shown in FIG. 7, etc.) include an RF transmitter, a television tower, a radio tower, a broadcasting station, a beacon, a cellular tower, a mobile platform, a stationary platform, a terrestrial RF emitter, a mobile RF emitter, a stationary RF emitter, an airborne RF emitter, an uncrewed RF emitter, an autonomous RF emitter, a jamming emitter, and/or the like. In some examples, one or more RF emitters disclosed herein includes an electronic jamming emitter (e.g., an electronic jamming beacon, etc.), although as described above the RF emitters may additionally or alternatively include any other type of emitter, source, beacon, and/or the like. For example, jamming emitters are typically used to disrupt and/or interfere with communication and navigation systems.

The system 100 includes one or more modules (e.g., the modules 110, 112, 114) that operatively connected to the memory 104, the processor 102, and/or each other for performing various functions, operations, and/or the like of the system 100. In the illustrated implementation, the system 100 includes an RF sensor module 110, a mapping module 112, and a navigation module 114. The architecture of the modules 110, 112, and 114 of the system 100 enables comprehensive RF landscape mapping and navigation using an RF landscape map, ultimately enhancing operational effectiveness of the system 100 in environments with RF emitters.

In some examples, the system 100 performs a method that includes: monitoring an RF spectrum within an area to detect RF emissions from RF emitters; acquiring emission data of the detected RF emissions; processing the acquired emission data to determine approximate locations of the RF emitters; and compiling the determined approximate locations and acquired emission data into an RF landscape map of the area.

In some examples, the system 100 performs a method that includes: accessing an RF landscape map that comprises approximate locations and emission data of RF emitters; and defining a navigation path using the approximate locations and the emission data of at least some of the RF emitters of the RF landscape map.

The system 100 includes one or more RF sensors 116 that are configured to monitor an RF spectrum within an area (e.g., along a navigation path such as, but not limited to, a flight path, a ground path, a marine path, and/or the like) to detect RF emissions from RF emitters (e.g., mobile and/or stationary RF emitters located along a navigation path, mobile and/or stationary RF emitters located within a detection range of the system 100, mobile and/or stationary RF emitters located within a detection range of a mobile platform, mobile and/or stationary RF emitters located within a detection range of a stationary platform, etc.). For example, each RF sensor 116 is configured to acquire emission data of detected RF emissions (e.g., signals, other emissions, etc.) of the RF emitters. For example, and although other ranges are within the scope of the present disclosure (e.g., any range of frequencies of the radio spectrum, any range from approximately 3 KHz to approximately 3,000 THz, etc.), one or more of the RF sensors 116 may be configured to scan a frequency range between approximately 1.2 GHz and approximately 5.8 GHz. The RF sensors 116 may include any number and/or different types of sensors, including, but not limited to, short-range radar, close-range radar, medium-range radar, long-range radar, frequency modulated continuous wave (FMCW) radar, and/or the like. In some examples, one or more of the RF sensors 116 includes a software defined radio (SDR).

Emission data of the detected RF emissions that is acquired by the RF sensors 116 may include, but is not limited to, frequency, frequency characteristics, signal strength, directional orientation, positional coordinates, locations, modulation patterns, persistence profiles, metadata, metadata corresponding to an RF emission, metadata corresponding to an RF emitter (e.g., an emitter type, an emitter characteristic, an identification of friend or foe (IFF), etc.), metadata corresponding to an environmental condition, any other metadata, emission data detected and/or received at different times, and/or the like. In some examples, at least some of the emission data is acquired by the RF sensors 116 onboard a mobile platform. In some examples, at least some of the emission data utilized by the system 100 is received from one or more sensors that are not a component of the system 100 (e.g., located remote, offboard, and/or the like from the system 100, etc.).

Optionally, the system 100 includes one or more non-RF sensors 118 that are configured to acquire non-RF data, for example for incorporation (e.g., integration) of non-RF information into an RF landscape map (e.g., generated by the system 100, received by the system 100, etc.). The non-RF sensor(s) 118 may include any number and/or different types of non-RF sensors, such as, but not limited to, cameras, infrared (IR) cameras, first person view (FPV) cameras, visual (visible spectrum) cameras, acoustic sensors, microphones, optical sensors, thermal sensors, IR sensors, microwave sensors, environmental monitors, LiDAR systems, x-ray detectors, electromagnetic field detectors, and/or the like. Non-RF data acquired by the non-RF sensors 118 may include, but is not limited to, audio information, audio clues, visual information, visual cues, IR information, heat signatures, environmental information, environmental variables, wind patterns, wind speeds, wind direction, terrain features, terrain information, video footage, thermal information, temperatures, temperature measurements, and/or the like. In some examples, at least some of the non-RF data is acquired by the non-RF sensors 118 onboard a mobile platform. In some examples, at least some of the non-RF data utilized by the system 100 is received from one or more sensors that are not a component of the system 100 (e.g., located remote, offboard, and/or the like from the system 100, etc.).

The multi-sensor approach of aspects of the disclosure, for example, refines RF emitter localization, for example providing additional data (e.g., a heat signature, etc.) to validate RF emitter presence, enhance an RF landscape map, enhance navigation, optimize engagement strategies, aid in the approach and/or reaffirmation of RF emitter positions, and/or the like.

In some examples, the system 100 is configured to collect at least some of the emission data and/or non-RF data from one or more stationary platforms. In some examples, the system 100 is configured to collect at least some of the emission data and/or non-RF data by navigating one or more mobile platforms along one or more navigation paths. In some examples, the mobile platform is an aircraft that is deployed and ascends to a flight altitude (e.g., predefined and/or predetermined), for example an altitude that optimizes the reception of RF signals from a variety of RF emitters within a designated mapping area. As the mobile platform traverses (e.g., moves along) the navigation path, the RF sensors 116 detect RF emissions of the RF emitters within the mapping area. For example, the RF sensors 116 may continuously monitor the RF spectrum for emissions from the RF emitters as the mobile platform traverses the navigation path. In other examples, the RF sensors 116 may periodically and/or intermittently monitor the RF spectrum for emissions from the RF emitters as the mobile platform traverses the navigation path. In some examples, the navigation path is continuous, but a navigation path may be discontinuous in other examples.

The RF sensor module 110 is configured to receive the emission data acquired by the RF sensors 116 and the non-RF data acquired by the non-RF sensors 118. In some examples, following the reception of the emission data, the RF sensor module 110 proceeds to identify the various parameters of the emission data. Any parameters of the emission data may be identified, such as, but not limited to, the frequency characteristics, signal strength, directional orientation, and/or the like. For example, the identification process of the emission data may involve measuring the intensity, power level, and/or the like of a signal.

The mapping module 112 is configured to receive the acquired emission data from the RF sensor module 110 and process the acquired emission data to determine approximate locations of the RF emitters. In some examples, the mapping module 112 determines the approximate locations of the RF emitters by processing the acquired emission data using signal strength, a signal strength variation, a directional orientation, a directional orientation variation, a positional coordinate, a positional offset, a locational offset, another known radio direction finding and/or geolocation method, and/or the like. In some examples, the mapping module 112 uses location triangulation to determine the approximate locations of the RF emitters. For example, the mapping module 112 triangulates the approximate locations (e.g., positions) of detected RF emitters, for example using algorithms that account for signal strength variances, location and/or positional data of the mobile platform, and/or the like to refine the spatial accuracy of an RF emitter's location. In some examples, the acquired emission data is processed and/or the approximate locations of the RF emitters are determined by the mapping module 112 onboard a mobile platform.

The mapping module 112 is configured to perform RF landscape mapping. For example, the mapping module 112 compiles the determined approximate locations and acquired emission data into an RF landscape map (e.g., the RF landscape map 200 shown in FIG. 2, etc.) that includes the approximate locations of the RF emitters and the corresponding emission data of the RF emitters. In some examples, the mapping module 112 combines emission data and/or locations collected from a network of two or more systems 100 and/or platforms. Optionally, the mapping module 112 compiles the triangulated RF emitter locations along with their frequency characteristics into a comprehensive RF landscape map. In some examples, the determined approximate locations and acquired emission data are compiled by the mapping module 112 into the RF landscape map onboard a mobile platform.

FIG. 2 illustrates a non-limiting example of an RF landscape map 200 according to an implementation. As shown in the example of FIG. 2, the RF landscape map 200 includes a topography map of a defined area 206. The various approximate locations of known RF emitters 202 are marked on the topography map with corresponding icons that optionally indicate the type of RF emitter 202 (e.g., as is shown in FIG. 2, etc.). Optionally, emission data (ED) 204 corresponding to one or more of the RF emitters 202 is displayed on the topography map, for example as is shown in FIG. 2. Although shown as a topography map, in addition or alternatively, the RF landscape map 200 may include any other type of map.

Optionally, the RF landscape map compiled by the mapping module 112 includes an indication of the absence (e.g., sudden, prolonged, etc.) of one or more RF emitters that have been previously known to be within the area of the RF landscape map. For example, the indication of the absence of an RF emitter may include a known location of the RF emitter, an identification of the RF emitter, a type of the RF emitter, whether the absence is prolonged, whether the absence is sudden, a duration of time since an emission from the RF emitter has been detected, an expected time the RF emitter is expected to become active, and/or the like. FIG. 2 illustrates an example of one implementation of displaying a ghosted icon that indicates on the RF landscape map 200 the approximate location of an RF emitter 202a that is currently absent but was previously known to be within the area of the RF landscape map 200.

Referring again to FIG. 1, in some examples, the mapping module 112 is configured to integrate non-RF data into the RF landscape map. Non-RF data integrated into the RF landscape map by the mapping module 112 may include, but is not limited to, audio information, audio clues, visual information, visual cues, IR information, heat signatures, environmental information, environmental variables, wind patterns, wind speeds, wind direction, terrain features, terrain information, video footage, thermal information, temperatures, temperature measurements, and/or the like. The additional data provided within the RF landscape map by the non-RF data provides granularity and augments the utility of the RF landscape map for navigation purposes.

The compiled RF landscape map may be stored in an onboard storage system of the mobile platform, may be transmitted to a stationary platform (e.g., a centralized control station, etc.) and/or another mobile platform, and/or the like.

In some examples, the system 100 conducts periodic map validation and/or adjustment checks, for example to assess signal consistency, adjust navigation parameters, and/or the like. For example, anomalies detected in RF data may be logged for subsequent analysis, immediate data re-evaluation, and/or the like. Some examples of the mapping module 112 are configured to update the RF landscape map with acquired data during a subsequent navigation of a navigation path within the area covered by the RF landscape map. In other words, the RF landscape map can be dynamically updated as new data is acquired during subsequent navigations (e.g., flights) of the area, for example facilitating that the RF landscape map is a relatively accurate representation of the RF environment.

Referring now to the navigation module 114, the system 100 is configured to navigate using the RF landscape map. For example, the navigation module 114 is configured to access an RF landscape map that includes approximate locations and emission data of RF emitters. The RF landscape map is generated by the system 100 and/or another system. In some examples, the RF landscape map is accessed by the navigation module 114 onboard a mobile platform.

Using the accessed RF landscape map, the navigation module 114 defines a navigation path (e.g., a flight path, a ground path, a marine path, etc.) using the approximate locations and the emission data of at least some of the RF emitters of the RF landscape map. Optionally, defining the navigation path comprises defining a flight path for a UAV. In some examples, the defined navigation path is defined by the navigation module 114 onboard a mobile platform. In some examples, the navigation path defined by the navigation module 114 is predetermined (e.g., determined by the navigation module 114 or another navigation module, before the mobile platform begins moving, etc.).

A mobile platform that includes the system 100 onboard can navigate through an area covered by the RF landscape map by following the defined navigation path. For example, in implementations wherein the defined navigation path is a flight path, a mobile platform navigates along the flight path that has been defined based on the RF landscape map. In some examples, traversing the defined navigation path includes deploying an aircraft to ascend to an altitude along the navigation path.

In some examples, one or more of the RF emitters are used as a waypoint along the defined navigation path. Example waypoints include a waypoint buoy, a waypoint reference, and/or an active waypoint. In other words, some implementations of the defined navigation path use RF emitter locations as waypoints within the defined navigation path that are used by the mobile platform to traverse the navigation path. In other words, in some examples, the navigation module defines the navigation path by selecting at least one of the RF emitters as a waypoint of the navigation path. For example, the navigation module 114 and/or another system onboard the mobile platform may determine, implement, adjust, and/or the like a heading, speed, altitude, and/or the like of the mobile platform and/or the navigation path based on the waypoints, for example to travel between the waypoints, to reach the next waypoint, and/or the like. In some examples, the navigation module 114 defines the navigation path as including a heading, speed, altitude, and/or the like of the mobile platform that enables the mobile platform to travel between the waypoints defined by the RF emitter locations.

FIG. 3 illustrates a non-limiting example of a navigation path 300 using RF emitters 302 as waypoints according to an implementation. As shown in the example of FIG. 3, various RF emitters 302 are selected as waypoints 302 of the navigation path 300. The waypoints 302 can be followed by a mobile platform to traverse the navigation path 300.

Referring again to FIG. 1, in some examples, the system 100 (e.g., the navigation module 114) is configured to adapt in real-time to discrepancies and/or updates. For example, the system 100 is configured to, in some examples, change the defined navigation path of the mobile platform based on real-time information. The real-time information may be real-time information that is different than the RF landscape map, and/or real-time information acquired while the mobile platform is moving (e.g., traversing the defined navigation path). Optionally, changing the defined navigation path includes changing (e.g., refining) navigation parameters based on a signal strength variation, a signal strength discrepancy, a discrepancy between detected RF emissions and the emission data of the RF landscape map, a positional offset between detected RF emissions and the emission data of the RF landscape map, a locational offset between detected RF emissions and the emission data of the RF landscape map, and/or the like. Optionally, changing the defined navigation path includes a heading, speed, altitude, and/or the like of the mobile platform and/or the navigation path based on the real-time information. In some examples, the defined navigation path is changed onboard a mobile platform.

Another example of the system 100 adapting in real-time includes updating the RF landscape map based on the real-time information. In some examples, updating the RF landscape map includes changing (e.g., refining) the RF landscape map based on a signal strength variation, a signal strength discrepancy, a discrepancy between detected RF emissions and the emission data of the RF landscape map, a positional offset between detected RF emissions and the emission data of the RF landscape map, a locational offset between detected RF emissions and the emission data of the RF landscape map, and/or the like. For example, updating the RF landscape map may be based on a discrepancy between an expected RF signal characterized in the RF landscape map and a real-time RF signal detected during a navigation of the navigation path. Updating of the RF landscape map may include any changes to the existing map. Optionally, updating the RF landscape map includes adjusting a location and/or a signal characteristic of at least one of the RF emitters, for example to align with the newly acquired information. In some examples, the RF landscape map is updated onboard a mobile platform.

Optionally, the navigation module 114 is configured to define the navigation path using non-RF data. In some examples, the navigation module 114 is configured to define the navigation path by continuously comparing real-time RF signal data detected during a flight operation with the RF landscape map to align a position of a mobile platform, adjust a course of the mobile platform, and/or the like.

The navigation module 114 is configured, in some examples, to use the RF landscape map to avoid one or more RF emitters. For example, the RF landscape map may include an approximate location and/or at least one frequency characteristic of one or more of the RF emitters that is to be avoided. To determine which RF emitters are to be avoided, some examples use the RF landscape map to identify a spatial extent, a coverage pattern, and/or the like, of one or more of the RF emitters.

In some examples, the navigation module 114 is configured to define an avoidance path that attempts to avoid one or more of the RF emitters. (e.g., minimize or eliminate signal interaction with). For example, the navigation module 114 may define the avoidance path by assessing (e.g., onboard a mobile platform, etc.) a proximity of a mobile platform to one or more of the RF emitters using the RF landscape map. Optionally, the system 100 (e.g., the navigation module 114) is configured to continuously monitor the RF spectrum such as during a flight operation to detect real-time emissions from known RF emitters and assess the proximity of the mobile platform to one or more of the RF emitters based on the RF landscape map.

In some examples, the navigation module 114 defines the avoidance path by including recalibrating a flight path, a heading, a speed, an altitude, and/or the like that will enable the mobile platform to maintain a threshold distance from the RF emitters that are to be avoided. In some examples, the avoidance path is defined is adjusted using a discrepancy between real-time RF data and an influence zone of one or more of the RF emitters as the mobile platform is moving.

In some examples, the system 100 (e.g., the navigation module 114) is configured to adjust a mobile platform's navigation path, as the mobile platform is moving, by recalibrating heading, speed, altitude, and/or the like to maintain a safe distance from one or more of the RF emitters, for example based on discrepancies between real-time RF data and the RF landscape map's characterization of an influence zone of one or more of the RF emitters.

Optionally, the system 100 is configured to refine an avoidance strategy by incorporating a real-time analysis of an RF signal strength variation, potential environmental factors, and/or the like. In some examples, adjusting an avoidance strategy includes using non-RF data. Moreover, some examples of the system 100 integrate the non-RF data to enhance avoidance strategies, for example by considering environmental variables (e.g., wind patterns, and/or terrain features) that may affect the mobile platform's maneuverability, path optimization, and/or the like.

FIG. 4 illustrates a non-limiting example of an avoidance path 400 according to an implementation. The avoidance path 400 attempts to avoid one or more RF emitters 402. As shown in the example of FIG. 4, the avoidance path 400 includes various waypoints 404 that can be followed by a mobile platform to traverse the avoidance path 400 and avoid the RF emitters 402.

Referring again to FIG. 1, in some implementations, the system 100 is used to provide a standalone RF mapping UAV and/or other mobile platform. In this approach, the system 100 employs a singular platform equipped with RF sensors to independently map an area by detecting and compiling data related to RF emitters (e.g., equipped exclusively with RF sensors). The standalone configuration ensures a streamlined operation focusing solely on RF landscape mapping, for example without reliance on additional sensor data. Such an implementation is particularly useful in scenarios where the environment is densely populated with RF sources, for example providing ample reference points for navigation.

Some implementations of the system 100 provide a multi-sensor mapping and navigation UAV. This implementation integrates RF sensors with supplementary onboard sensors such as, but not limited to, cameras, environmental monitors, LiDAR systems, and/or the like. The utilization of multiple sensor types allows the UAV to gather comprehensive data, for example enhancing the RF landscape map with visual and/or environmental information. This integration provides enhanced situational awareness and navigation reliability, for example in complex and/or dynamically changing environments. For example, the additional data layers augment the RF landscape map with features that are independently verifiable, for example increasing overall map accuracy.

A hybrid GPS/RF navigation system is provided by the system 100 in some implementations. Such a hybrid configuration employs UAVs capable of navigating using both conventional GPS data and the RF landscape map. In areas where GPS reliability is compromised, the UAV may switch and/or supplement their navigation systems with the RF landscape map, for example to maintain trajectory and/or accuracy. This hybrid navigation method provides a fail-safe measure against GPS signal loss and/or ensures continuous operational capability, for example in diverse environments.

As described above, in some examples, the system 100 combines RF emissions detected from multiple (at least two) platforms (e.g., stationary and/or mobile platforms, etc.) into a single RF landscape map. In one example, one or more of the platforms is a backpack carried by an individual. For example, an individual carrying the backpack may continuously or intermittently monitor for RF emissions as the individual moves about the area of the RF landscape map.

One example of using more than one platform and/or system 100 to perform RF landscape mapping will now be described. Each platform and/or system produces a local RF landscape map segment specific to the platform and/or system's area of operation. The local RF map segments may be transmitted to a central station (e.g., in real-time, after a threshold period of time, after a predefined and/or predetermined period of time, etc.). At the central station, incoming data from multiple platforms is simultaneously collected and indexed. The individual RF landscape map segments are consolidated and compiled (e.g., using a data fusion algorithm, etc.) into a unified (e.g., comprehensive, coherent, etc.) RF landscape map. For example, the consolidation and compiling process may utilize spatial overlays, signal correlation methods, and/or the like, for example to adjust overlapping data points, resolve discrepancies, enhance positional accuracy across the entire scanned area, and/or the like. In some examples, the unified RF landscape map integrates the frequency information and spatial positioning of detected RF transmitters across the monitored landscape, for example ensuring that the representation is both comprehensive and updated with the latest readings from all contributing platforms. In some examples, the RF landscape map remains dynamic, with updates occurring as additional data is received from the platforms. This ensures that the Rf landscape map reflects any temporal and/or environmental changes within the area, for example providing a reliable and current navigation reference.

Optionally, the position of each RF emitter is estimated using triangulation, for example by collecting signal strength, directional data, and/or the like from at least two distinct platforms and/or systems. For example, the known positions of the platforms and/or systems are used to calculate the intersection points of the RF signal paths. Variations in signal strength due to distance and/or environmental factors may be normalized, for example using a path-loss model and/or the like. For example, a common model, such as the log-distance path loss model, may be applied to adjust the recorded signal strengths to approximate true values. When overlapping data points from multiple platforms are present, a weighted averaging method is applied, in some examples. For example, weights may be assigned based on factors such as, but not limited to, signal strength reliability, platform positional accuracy, and/or the like, for example ensuring that more reliable readings have a greater influence on the final position calculation. A Kalman filter, and/or similar algorithm, may be employed to optimally estimate the positions of RF emitters from noisy data inputs. This filter processes incoming data iteratively, updating predictions and reducing uncertainty through covariance analysis. In some examples, spatial correlation techniques combine signal readings across different frequencies, for example compensating for multipath effects and/or signal diffraction. This method aligns data layers from various frequency bands and emitter types to form a cohesive RF map. In some examples, linear interpolation and/or spline methods are used to fill gaps in the data across the area being mapped. The RF landscape map may be updated dynamically as new data points are collected, for example adjusting interpolated values to reflect changes and/or new discoveries in real-time.

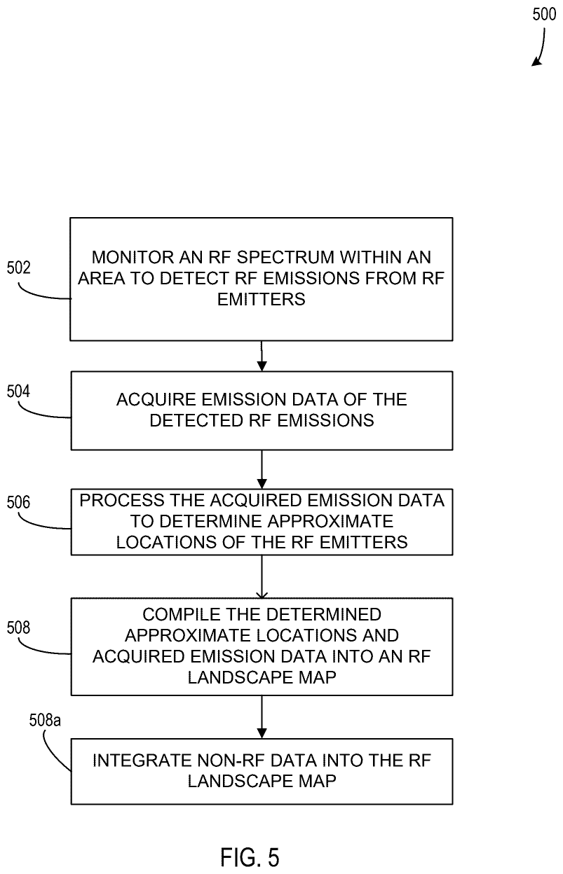

FIG. 5 is a flowchart illustrating an example of a method 500 of operations, functions, and/or the like of the system 100 (FIG. 1). At 502, the method 500 includes monitoring a radio frequency (RF) spectrum within an area to detect RF emissions from terrestrial RF emitters. The method 500 includes acquiring, at 504, emission data of the detected RF emissions, and processing, at 506, the acquired emission data to determine approximate locations of the RF emitters. At 508, the method 500 includes compiling the determined approximate locations and acquired emission data into an RF landscape map of the area. Optionally, compiling at 508 the determined approximate locations and acquired emission data into the RF landscape map includes integrating, at 508a, non-RF data into the RF landscape map.

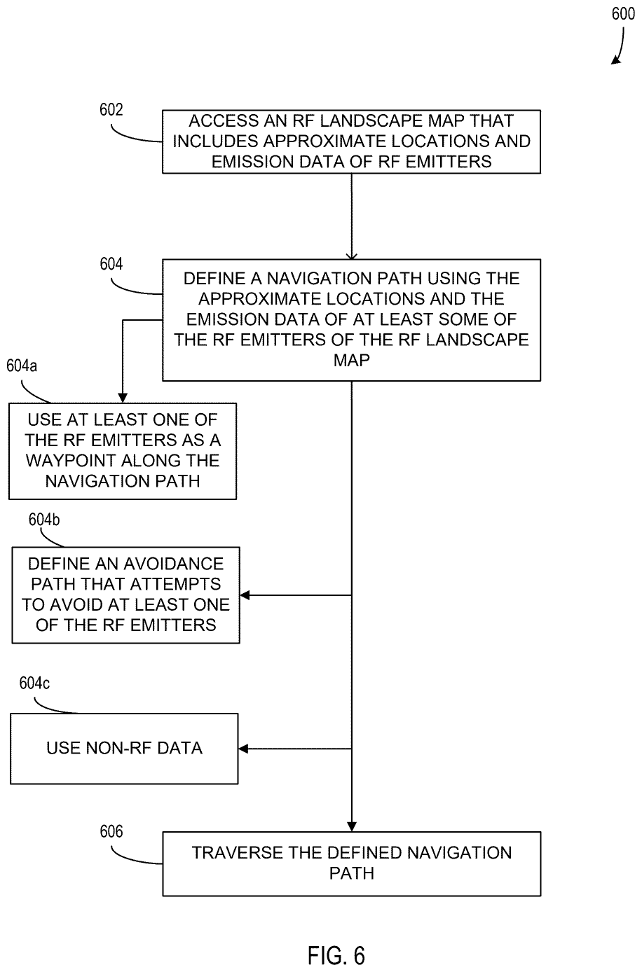

FIG. 6 is a flowchart illustrating an example of a method 600 of operations, functions, and/or the like of the system 100 (FIG. 1). At 602, the method 600 includes accessing a radio frequency (RF) landscape map that includes approximate locations and emission data of RF emitters. At 604, the method 600 includes defining a navigation path using the approximate locations and the emission data of at least some of the RF emitters of the RF landscape map. In some examples, the method 600 further includes traversing, at 606, the defined navigation path.

Optionally, defining at 604 the navigation path includes using, at 604a, at least one of the RF emitters as a waypoint along the navigation path. In some examples, defining at 604 the navigation path includes defining, at 604b, an avoidance path that attempts to avoid at least one of the RF emitters. Defining at 604 the navigation path optionally includes using non-RF data.

FIG. 7 illustrates an exemplary implementation of the system 100 being deployed onboard a mobile platform 700. The system 100 is configured to perform the operations disclosed herein (e.g., monitoring, acquiring, processing, compiling, integrating, accessing, defining, traversing, transmitting, storing, navigating, deploying, scanning, identifying, detecting, characterizing, locating, prioritizing, selecting, generating, etc.) from onboard the mobile platform 700. For example, the system 100 may perform signal landscape mapping (e.g., creating a new RF landscape map of signals emitted by the RF emitters 702, updating an existing RF landscape map of signals emitted by the RF emitters 702, etc.), for example as the mobile platform 700 moves along a path (e.g., a flight path, a ground path, a marine path, etc.) and/or while the mobile platform 700 is stationary. Another example includes navigating the mobile platform 700 along a navigation path (e.g., a flight path, a ground path, a marine path, etc.) utilizing an RF landscape map of known RF emitters 702 and/or RF emitters 702 detected while the mobile platform 700 moves along the navigation path.

In some examples, the system 100 is configured to locate the source of the signals of interest that the system 100 determines to be relevant. For example, the system 100 may locate RF emitters 702 (e.g., located on an RF landscape map, detected while the mobile platform 700 moves along the path, etc.) that the system 100 has characterized (or knows) as one or more of an unknown emitter, an emitter that is located in unauthorized airspace, an emitter that is not authorized to approach the location of the mobile platform 700, a threat (e.g., a physical threat, an interference threat, a jamming threat, etc.), and/or the like. Suitable actions may be taken by the system 100 when an RF emitter 702 is characterized as disclosed herein. For example, maneuvering the mobile platform 700 to avoid one or more RF emitters, enforcement actions, threat mitigation, and/or the like may be generated, requested, commanded, initiated, and/or the like by the system 100.

Although shown as a UAV rotorcraft, the mobile platform 700 is not limited thereto but rather may include any other type of mobile platform.

### Exemplary Operating Environment

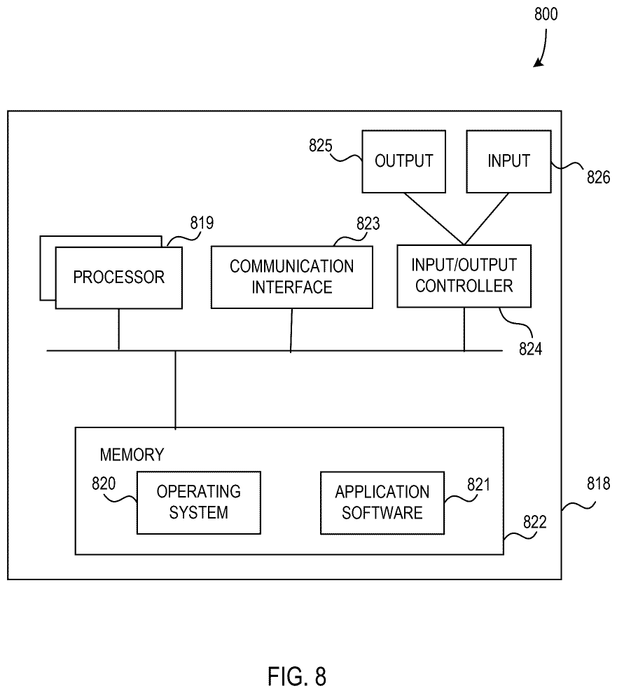

The present disclosure is operable with a computing apparatus according to an embodiment as a functional block diagram 800 in FIG. 8. In an example, components of a computing apparatus 818 are implemented as a part of an electronic device according to one or more implementations described in this specification. The computing apparatus 818 comprises one or more processors 819 which may be microprocessors, controllers, or any other suitable type of processors for processing computer executable instructions to control the operation of the electronic device. Alternatively, or in addition, the processor 819 is any technology capable of executing logic or instructions, such as a hard-coded machine. In some examples, platform software comprising an operating system 820 and/or any other suitable platform software is provided on the apparatus 818 to enable application software 821 to be executed on the device.

In some examples, computer executable instructions are provided using any computer-readable media that is accessible by the computing apparatus 818. Computer-readable media include, for example, computer storage media such as a memory 822 and communications media. Computer storage media, such as a memory 822, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 822) is shown within the computing apparatus 818, it will be appreciated by a person skilled in the art, that, in some examples, the storage is distributed or located remotely and accessed via a network or other communication link (e.g., using a communication interface 823).

Further, in some examples, the computing apparatus 818 comprises an input/output controller 824 configured to output information to one or more output devices 825, for example a display (e.g., displaying a GUI) or a speaker, which are separate from or integral to the electronic device. Additionally, or alternatively, the input/output controller 824 is configured to receive and process an input from one or more input devices 826, for example, a keyboard, a microphone, or a touchpad. In one example, the output device 825 also acts as the input device. An example of such a device is a touch sensitive display. The input/output controller 824 may also output data to devices other than the output device, e.g., a locally connected printing device. In some examples, a user provides input to the input device(s) 826 and/or receives output from the output device(s) 825.

The functionality described herein can be performed, at least in part, by one or more hardware logic components. According to an embodiment, the computing apparatus 818 is configured by the program code when executed by the processor 819 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Aspects of the disclosure include a method that includes monitoring a radio frequency (RF) spectrum within an area to detect RF emissions from RF emitters; acquiring emission data of the detected RF emissions; processing the acquired emission data to determine approximate locations of the RF emitters; and compiling the determined approximate locations and acquired emission data into an RF landscape map of the area.

In some examples, the method further includes navigating a mobile platform along a navigation path, wherein monitoring the RF spectrum within the area comprises monitoring the RF spectrum along the navigation path.

In some examples, monitoring the RF spectrum within the area includes monitoring the RF spectrum using a mobile platform.

In some examples, monitoring the RF spectrum within the area includes monitoring the RF spectrum using a stationary platform.

In some examples, at least one of the RF emitters is a stationary RF emitter.

In some examples, at least one of the RF emitters is a mobile RF emitter.

In some examples, the RF landscape map includes at least one of approximate locations of the RF emitters, the emission data of the RF emitters, an emitter characteristic, an emitter type, or an identification of friend or foe (IFF).

In some examples, the method further includes navigating an uncrewed aerial vehicle (UAV) along a flight path.

In some examples, acquiring the emission data of the detected RF emissions includes acquiring the emission data onboard an aircraft.

In some examples, processing the acquired emission data to determine the approximate locations of the RF emitters includes processing the acquired emission data onboard an aircraft.

In some examples, compiling the determined approximate locations and acquired emission data into the RF landscape map includes compiling the determined approximate locations and acquired emission data into the RF landscape map onboard an aircraft.

In some examples, the emission data includes at least one of a frequency characteristic, a signal strength, a directional orientation of the detected RF emissions, or metadata.

In some examples, the method further includes deploying an aircraft to ascend to an altitude.

In some examples, the RF emitters include at least one of an RF transmitter, such as a television tower, a radio tower, a broadcasting station, a beacon, or a cellular tower.

In some examples, processing the acquired emission data to determine the approximate locations of the RF emitters includes using at least one of a signal strength, a signal strength variation, a directional orientation, a directional orientation variation, a positional coordinate, a positional offset between detected RF emissions and the emission data of the RF landscape map, or a locational offset between detected RF emissions and the emission data of the RF landscape map.

In some examples, the method further includes updating the RF landscape map with acquired data during a flight operation.

In some examples, compiling the determined approximate locations and acquired emission data into the RF landscape map includes integrating non-RF data into the RF landscape map.

In some examples, the non-RF data is acquired by at least one sensor onboard an aircraft.

In some examples, the RF landscape map includes non-RF data including at least one of visual information, a visual cue, environmental information, an environmental variable, a wind pattern, a wind speed, a wind direction, a terrain feature, video footage, or a temperature.

In some examples, the method further includes storing the compiled RF landscape map in an onboard storage system of an aircraft.

In some examples, the method further includes transmitting the compiled RF landscape map from an aircraft to at least one of a centralized control station or another aircraft.

Aspects of the disclosure include a system that includes: at least one processor; and a memory comprising computer program code, the memory and the computer program code configured to, with the at least one processor, cause the at least one processor to: monitor a radio frequency (RF) spectrum within an area to detect RF emissions from RF emitters; acquire emission data of the detected RF emissions; process the acquired emission data to determine approximate locations of the RF emitters; and compile the determined approximate locations and acquired emission data into an RF landscape map of the area.

In some examples, the system is configured to be carried and operated onboard an aircraft.

Aspects of the disclosure include a method that includes: accessing a radio frequency (RF) landscape map that comprises approximate locations and emission data of RF emitters; and defining a navigation path using the approximate locations and the emission data of at least some of the RF emitters of the RF landscape map.

In some examples, the method further includes traversing the defined navigation path.

In some examples, the mobile platform is an aircraft, the navigation path is a flight path, and the method further includes navigating the aircraft along the flight path.

In some examples, accessing the RF landscape map includes accessing the RF landscape map onboard an aircraft.

In some examples, defining the navigation path comprises defining the navigation path onboard an aircraft.

In some examples, the emission data includes at least one of a frequency characteristic, a signal strength, or a directional orientation.

In some examples, the method further includes deploying an aircraft to ascend to an altitude along the navigation path.

In some examples, the RF emitters include at least one of an RF transmitter, a television tower, a radio tower, a broadcasting station, a beacon, or a cellular tower.

In some examples, defining the navigation path comprises defining the navigation path as a flight path for an uncrewed aerial vehicle (UAV).

In some examples, defining the navigation path includes using at least one of the RF emitters as a waypoint along the navigation path.

In some examples, defining the navigation path includes including at least one of the RF emitters as at least one of a waypoint buoy, a waypoint reference, or an active waypoint along the navigation path.

In some examples, the RF landscape map includes an approximate location and at least one frequency characteristic of at least one of the RF emitters that is to be avoided.

In some examples, defining the navigation path includes using the RF landscape map to identify at least one of a spatial extent or a coverage pattern of at least one of the RF emitters.

In some examples, defining the navigation path includes defining an avoidance path that attempts to avoid at least one of the RF emitters.

In some examples, defining the navigation path includes assessing, onboard a mobile platform, a proximity of the mobile platform to at least one of the RF emitters using the RF landscape map.

In some examples, defining the navigation path includes assessing, onboard an aircraft during a flight operation, a proximity of the aircraft to at least one of the RF emitters using the RF landscape map.

In some examples, defining the navigation path includes adjusting the navigation path by recalibrating at least one of a heading, a speed, or an altitude to maintain a threshold distance from at least one of the RF emitters.

In some examples, defining the navigation path includes adjusting the navigation path by recalibrating at least one of a flight path, a heading, a speed, or an altitude dynamically while a mobile platform is traversing the navigation path.

In some examples, defining the navigation path includes adjusting the navigation path using a discrepancy between real-time RF data and an influence zone of at least one of the RF emitters on the RF landscape map.

In some examples, defining the navigation path includes at least one of re-evaluating or refining an avoidance strategy.

In some examples, defining the navigation path includes at least one of re-evaluating or refining an avoidance strategy by incorporating a real-time analysis of at least one of RF signal strength variations or potential environmental factors.

In some examples, the method further includes refining navigation parameters using at least one of a signal strength variation, a signal strength discrepancy, a discrepancy between detected RF emissions and the emission data of the RF landscape map, a positional offset between detected RF emissions and the emission data of the RF landscape map, or a locational offset between detected RF emissions and the emission data of the RF landscape map.

In some examples, the method further includes refining navigation parameters onboard an aircraft during a flight operation using at least one of a signal strength variation, a signal strength discrepancy, a discrepancy between detected RF emissions and the emission data of the RF landscape map, a positional offset between detected RF emissions and the emission data of the RF landscape map, or a locational offset between detected RF emissions and the emission data of the RF landscape map.

In some examples, the method further includes updating the RF landscape map using a discrepancy between an expected RF signal characterized in the RF landscape map and a real-time RF signal data detected during a navigation of the navigation path.

In some examples, the method further includes updating the RF landscape map by adjusting at least one of a location or a signal characteristic of at least one of the RF emitters to align with newly acquired RF data.

In some examples, the method further includes updating the RF landscape map with acquired data during a flight operation.

In some examples, defining the navigation path comprises using non-RF data.

In some examples, the non-RF data is acquired by at least one sensor onboard an aircraft.

In some examples, using the non-RF data includes using at least one of visual information, a visual cue, environmental information, an environmental variable, a wind pattern, a wind speed, a wind direction, a terrain feature, video footage, or a temperature.

In some examples, using the non-RF data includes adjusting an avoidance strategy using the non-RF data.

In some examples, defining the navigation path includes continuously comparing real-time RF signal data detected during a flight operation with the RF landscape map to at least one of align a position of an aircraft or adjust a course of the aircraft.

Aspects of the disclosure include a system that includes: a processor; and a memory comprising computer program code, the memory and the computer program code configured to, with the processor, cause the processor to: access a radio frequency (RF) landscape map that comprises approximate locations and emission data of RF emitters; and define a navigation path using the approximate locations and the emission data of at least some of the RF emitters of the RF landscape map.

In some examples, the system is configured to be carried and operated onboard an aircraft.

Aspects of the disclosure include a method for a UAV to create an RF landscape map, including: deploying the UAV to ascend to a predetermined altitude suitable for optimal RF signal reception; initializing and verifying the operability of onboard RF sensors and communication modules; navigating the UAV along a predetermined flight path while continuously monitoring the RF spectrum to detect emissions from various RF emitters, including television, radio, and cellular towers; acquiring data concerning the frequency information, signal strengths, and directional orientations of detected RF transmissions; processing the acquired data to calculate approximate positions of the RF emitters by employing onboard computational resources and algorithms that account for signal strength variations and UAV positional coordinates; compiling the calculated positions and frequency characteristics into a dynamic RF landscape map that is updated with newly acquired data during the flight operation; optionally integrating additional non-RF data acquired by supplementary sensors, if available, into the RF landscape map to enhance its detail and utility for navigation purposes; and storing the RF landscape map and associated data in the UAV's onboard storage systems while transmitting the compiled map to a centralized control station or other neighboring UAVs for synchronized navigation or operational planning.

Aspects of the disclosure include a system for creating an RF landscape map using a UAV, including: a UAV equipped with RF sensing modules configured to detect RF emissions across a range of frequencies from emitters, including television, radio, and cellular towers; onboard computational resources integrated into the UAV for processing detected RF data to determine approximate positions and frequency characteristics of the emitters based on variations in signal strength and directional orientations; a dynamic mapping module operably connected to the computational resources, designed to compile the calculated positions and frequency characteristics into an RF landscape map that is continuously updated with newly acquired RF data during UAV operation; an onboard storage system for retaining the RF landscape map and associated data for secure archiving and retrieval; communication modules linked to the UAV's storage system for transmitting the RF landscape map to a centralized control station or neighboring UAVs to facilitate synchronized navigation or mission planning; and optional integration capabilities for supplementary sensors to acquire non-RF data such as visual and environmental information, enhancing the RF landscape map with additional detail and utility for varied navigation tasks.

Aspects of the disclosure include a method for navigating a UAV using a pre-existing RF landscape map, including: receiving the RF landscape map that includes positions and frequency characteristics of various RF emitters; initializing and verifying the operability of onboard RF sensors and navigation modules; deploying the UAV to ascend to a predetermined altitude suitable for effective signal interaction, ensuring optimal coverage of mapped RF emitters; utilizing the RF landscape map to define a navigation path, whereby mapped RF emitters serve as waypoint references for the UAV's trajectory; continuously comparing real-time RF signal data detected during flight operations with the RF landscape map to align the UAV's position and adjust its course accordingly; employing onboard computational resources to refine navigation parameters based on signal strength variations and discrepancies between detected RF emissions and mapped data; optionally incorporating non-RF data from supplementary onboard sensors to further enhance navigation accuracy and adaptive decision-making; making adjustments to the UAV's flight path or speed based on updated calculations of positional offsets between its real-time location and the mapped RF landscape; executing coordinated navigation and operational planning through communication with additional UAVs or control stations using real-time navigation data and updates.

In some examples, the method further includes updating the RF landscape map in response to discrepancies between the real-time RF signal data detected during UAV navigation and the expected RF signals as characterized in the pre-existing RF landscape map, wherein the updating is performed by adjusting RF emitter positions or signal characteristics to align with the newly acquired RF data, thereby enhancing the accuracy of the RF landscape map for subsequent navigation tasks.

Aspects of the disclosure include a system for a UAV to navigate using an RF landscape map, including: a UAV equipped with RF sensing modules configured to detect RF emissions from RF emitters, including television, radio, and cellular towers, while in flight; a pre-existing RF landscape map stored in the UAV's onboard storage system, indicating the positions and frequency characteristics of said RF emitters; onboard computational resources for processing real-time RF data detected during flight operations and comparing it with the stored RF landscape map to determine the UAV's current position relative to mapped RF emitters; a navigation module operably connected to the computational resources, designed to utilize the RF landscape map and real-time RF signal data to define and adjust the UAV's flight path based on waypoint references provided by said RF emitters; communication modules for exchanging navigation data with additional UAVs or a centralized control station to enable coordinated navigation, operational planning, and map updates during missions; and optional integration capabilities for supplementary sensors to incorporate non-RF data such as visual and environmental information, thereby enhancing navigation accuracy and adaptive decision-making during UAV operations.

Aspects of the disclosure include a method for a UAV to utilize an RF landscape map to avoid known RF emitters, including: receiving an RF landscape map that includes the positions and frequency characteristics of various RF emitters identified as known emitters to be avoided; initializing and verifying the operability of onboard RF sensors and navigation modules to ensure accurate detection and processing of RF signals during flight operations; deploying the UAV to ascend to a predetermined altitude that maximizes its ability to detect and assess the RF emitters while maintaining optimal avoidance trajectories; utilizing the RF landscape map to identify the spatial extent and coverage patterns of the known emitters, thereby enabling the UAV to define an initial avoidance path that minimizes signal interaction with these RF emitters; continuously monitoring the RF spectrum during flight operations to detect real-time emissions from known RF emitters, employing onboard computational resources to assess the UAV's proximity to these RF emitters based on the stored RF landscape map; adjusting the UAV's flight path dynamically by recalibrating heading, speed, or altitude to maintain a safe distance from detected emitters, based on discrepancies between real-time RF data and the map's characterization of the emitters' influence zones; integrating non-RF data obtained from additional onboard sensors, if available, to enhance avoidance strategies by considering environmental variables such as wind patterns or terrain features that may affect the UAV's maneuverability or path optimization; continuously re-evaluating and refining the avoidance strategy by incorporating real-time analysis of RF signal strength variations and potential environmental factors that may influence the UAV's movement relative to the known emitters; and conducting communication with additional UAVs or a centralized control station to share real-time adjustments made during the avoidance procedure, facilitating coordinated efforts among a fleet of UAVs operating within the same environment.

Aspects of the disclosure include a system that includes comprising at least one processor; and a memory comprising computer program code, the memory and the computer program code configured to, with the at least one processor, cause the at least one processor to: monitor a radio frequency (RF) spectrum within an area to detect RF emissions from RF emitters; acquire emission data of the detected RF emissions; process the acquired emission data to determine approximate locations of the RF emitters; and compile the determined approximate locations and acquired emission data into an RF landscape map of the area.

In some examples, the memory and the computer program code are configured to, with the at least one processor, further cause the at least one processor to navigate a mobile platform along a navigation path utilizing the RF landscape map.

In some examples, the memory and the computer program code are configured to, with the at least one processor, further cause the at least one processor to define a navigation path utilizing the approximate locations and the emission data of at least some of the RF emitters of the RF landscape map.

In some examples, the memory and the computer program code are configured to, with the at least one processor, further cause the at least one processor to store the RF landscape map in a storage system.

In some examples, the memory and the computer program code are configured to, with the at least one processor, further cause the at least one processor to transmit the RF landscape map to at least one of a stationary platform or a mobile platform.

In some examples, the memory and the computer program code are configured to, with the at least one processor, further cause the at least one processor to navigate a mobile platform along a navigation path, wherein monitoring the RF spectrum within the area comprises monitoring the RF spectrum along the navigation path.

In some examples, the at least one processor is configured to monitor the RF spectrum within the area using at least one of a mobile platform or a stationary platform.

In some examples, at least one of: the RF landscape map comprises at least one of approximate locations of the RF emitters, the emission data of the RF emitters, an emitter characteristic, an emitter type, or an identification of friend or foe (IFF); or the emission data comprises at least one of a frequency characteristic, a signal strength, a directional orientation of the detected RF emissions, or metadata.

In some examples, the at least one processor is configured to process the acquired emission data to determine the approximate locations of the RF emitters utilizing at least one of a signal strength, a signal strength variation, a directional orientation, a directional orientation variation, a positional coordinate, a positional offset between detected RF emissions and the emission data of the RF landscape map, or a locational offset between detected RF emissions and the emission data of the RF landscape map.

In some examples, the memory and the computer program code are configured to, with the at least one processor, further cause the at least one processor to update the RF landscape map with acquired data during a flight operation.

In some examples, compiling the determined approximate locations and acquired emission data into the RF landscape map includes integrating non-RF data into the RF landscape map, wherein the non-RF data comprises at least one of visual information, a visual cue, environmental information, an environmental variable, a wind pattern, a wind speed, a wind direction, a terrain feature, video footage, or a temperature.

Aspects of the disclosure include a method that includes: monitoring a radio frequency (RF) spectrum within an area to detect RF emissions from RF emitters; acquiring emission data of the detected RF emissions; processing the acquired emission data to determine approximate locations of the RF emitters; and compiling the determined approximate locations and acquired emission data into an RF landscape map of the area.

In some examples, the method further includes at least one of: navigating a mobile platform along a navigation path utilizing the RF landscape map; defining a navigation path utilizing the approximate locations and the emission data of at least some of the RF emitters of the RF landscape map; storing the RF landscape map in a storage system; or transmitting the RF landscape map to at least one of a stationary platform or a mobile platform.

Aspects of the disclosure include a system that includes: at least one processor; and a memory comprising computer program code, the memory and the computer program code configured to, with the at least one processor, cause the at least one processor to: access a radio frequency (RF) landscape map that comprises approximate locations and emission data of RF emitters; define a navigation path utilizing the approximate locations and the emission data of at least some of the RF emitters of the RF landscape map; and deploy a mobile platform to follow the navigation path.

In some examples, the memory and the computer program code are configured to, with the at least one processor, further cause the at least one processor to at least one of: traverse the defined navigation path with the mobile platform; or deploy an aircraft to ascend to an altitude along the navigation path.

In some examples, the at least one processor is configured to define the navigation path at least one of: utilizing at least one of the RF emitters as a waypoint along the navigation path; or including at least one of the RF emitters as at least one of a waypoint buoy, a waypoint reference, or an active waypoint along the navigation path.

In some examples, the RF landscape map includes an approximate location and at least one frequency characteristic of at least one of the RF emitters that is to be avoided.

In some examples, defining the navigation path includes at least one of: utilizing the RF landscape map to identify at least one of a spatial extent or a coverage pattern of at least one of the RF emitters; defining an avoidance path that attempts to avoid at least one of the RF emitters; or assessing, onboard the mobile platform, a proximity of the mobile platform to at least one of the RF emitters using the RF landscape map.

In some examples, defining the navigation path comprises at least one of: defining the navigation path utilizing non-RF data; adjusting the navigation path by recalibrating at least one of a heading, a speed, or an altitude to maintain a threshold distance from at least one of the RF emitters; adjusting the navigation path by recalibrating at least one of a flight path, the heading, the speed, or the altitude dynamically while the mobile platform is traversing the navigation path; adjusting the navigation path using a discrepancy between real-time RF data and an influence zone of at least one of the RF emitters on the RF landscape map; at least one of adjusting, refining, or re-evaluating an avoidance strategy; at least one of adjusting, refining, or re-evaluating the avoidance strategy utilizing non-RF data; at least one of adjusting, refining, or re-evaluating the avoidance strategy by incorporating a real-time analysis of at least one of RF signal strength variations or potential environmental factors; continuously comparing real-time RF signal data detected during a flight operation with the RF landscape map to at least one of align a position of an aircraft or adjust a course of the aircraft; or refining navigation parameters utilizing at least one of a signal strength variation, a signal strength discrepancy, a discrepancy between detected RF emissions and the emission data of the RF landscape map, a positional offset between detected RF emissions and the emission data of the RF landscape map, or a locational offset between detected RF emissions and the emission data of the RF landscape map.

In some examples, the memory and the computer program code are configured to, with the at least one processor, further cause the at least one processor to update the RF landscape map at least one of: utilizing a discrepancy between an expected RF signal characterized in the RF landscape map and a real-time RF signal data detected during a navigation of the navigation path; by adjusting at least one of a location or a signal characteristic of at least one of the RF emitters to align with newly acquired RF data; or with acquired data during a flight operation.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
at least one processor; and
a memory comprising computer program code, the memory and the computer program code configured to, with the at least one processor, cause the at least one processor to:
monitor a radio frequency (RF) spectrum within an area to detect RF emissions from RF emitters;
acquire emission data of the detected RF emissions;
process the acquired emission data to determine approximate locations of the RF emitters; and
compile the determined approximate locations and acquired emission data into an RF landscape map of the area.

2. The system of claim 1, wherein the memory and the computer program code are configured to, with the at least one processor, further cause the at least one processor to navigate a mobile platform along a navigation path utilizing the RF landscape map.

3. The system of claim 1, wherein the memory and the computer program code are configured to, with the at least one processor, further cause the at least one processor to define a navigation path utilizing the approximate locations and the emission data of at least some of the RF emitters of the RF landscape map.

4. The system of claim 1, wherein the memory and the computer program code are configured to, with the at least one processor, further cause the at least one processor to store the RF landscape map in a storage system.

5. The system of claim 1, wherein the memory and the computer program code are configured to, with the at least one processor, further cause the at least one processor to transmit the RF landscape map to at least one of a stationary platform or a mobile platform.

6. The system of claim 1, wherein the memory and the computer program code are configured to, with the at least one processor, further cause the at least one processor to navigate a mobile platform along a navigation path, wherein monitoring the RF spectrum within the area comprises monitoring the RF spectrum along the navigation path.

7. The system of claim 1, wherein the at least one processor is configured to monitor the RF spectrum within the area using at least one of a mobile platform or a stationary platform.

8. The system of claim 1, wherein at least one of:
the RF landscape map comprises at least one of approximate locations of the RF emitters, the emission data of the RF emitters, an emitter characteristic, an emitter type, or an identification of friend or foe (IFF); or
the emission data comprises at least one of a frequency characteristic, a signal strength, a directional orientation of the detected RF emissions, or metadata.

9. The system of claim 1, wherein the at least one processor is configured to process the acquired emission data to determine the approximate locations of the RF emitters utilizing at least one of a signal strength, a signal strength variation, a directional orientation, a directional orientation variation, a positional coordinate, a positional offset between detected RF emissions and the emission data of the RF landscape map, or a locational offset between detected RF emissions and the emission data of the RF landscape map.

10. The system of claim 1, wherein the memory and the computer program code are configured to, with the at least one processor, further cause the at least one processor to update the RF landscape map with acquired data during a flight operation.

11. The system of claim 1, wherein compiling the determined approximate locations and acquired emission data into the RF landscape map comprises integrating non-RF data into the RF landscape map, wherein the non-RF data comprises at least one of visual information, a visual cue, environmental information, an environmental variable, a wind pattern, a wind speed, a wind direction, a terrain feature, video footage, or a temperature.

12. A method comprising:
monitoring a radio frequency (RF) spectrum within an area to detect RF emissions from RF emitters;
acquiring emission data of the detected RF emissions;
processing the acquired emission data to determine approximate locations of the RF emitters; and
compiling the determined approximate locations and acquired emission data into an RF landscape map of the area.

13. The method of claim 12, further comprising at least one of:
navigating a mobile platform along a navigation path utilizing the RF landscape map;
defining the navigation path utilizing the approximate locations and the emission data of at least some of the RF emitters of the RF landscape map;
storing the RF landscape map in a storage system; or
transmitting the RF landscape map to at least one of a stationary platform or the mobile platform.

14. A system comprising:
at least one processor; and
a memory comprising computer program code, the memory and the computer program code configured to, with the at least one processor, cause the at least one processor to:
access a radio frequency (RF) landscape map that comprises approximate locations and emission data of RF emitters;
define a navigation path utilizing the approximate locations and the emission data of at least some of the RF emitters of the RF landscape map; and
deploy a mobile platform to follow the navigation path.

15. The system of claim 14, wherein the memory and the computer program code are configured to, with the at least one processor, further cause the at least one processor to at least one of:
traverse the defined navigation path with the mobile platform; or
deploy an aircraft to ascend to an altitude along the navigation path.

16. The system of claim 14, wherein the at least one processor is configured to define the navigation path at least one of:
utilizing at least one of the RF emitters as a waypoint along the navigation path; or
including at least one of the RF emitters as at least one of a waypoint buoy, a waypoint reference, or an active waypoint along the navigation path.

17. The system of claim 14, wherein the RF landscape map comprises an approximate location and at least one frequency characteristic of at least one of the RF emitters that is to be avoided.

18. The system of claim 14, wherein defining the navigation path comprises at least one of:
utilizing the RF landscape map to identify at least one of a spatial extent or a coverage pattern of at least one of the RF emitters;
defining an avoidance path that attempts to avoid at least one of the RF emitters; or
assessing, onboard the mobile platform, a proximity of the mobile platform to at least one of the RF emitters using the RF landscape map.

19. The system of claim 14, wherein defining the navigation path comprises at least one of: defining the navigation path utilizing non-RF data;
adjusting the navigation path by recalibrating at least one of a heading, a speed, or an altitude to maintain a threshold distance from at least one of the RF emitters;
adjusting the navigation path by recalibrating at least one of a flight path, the heading, the speed, or the altitude dynamically while the mobile platform is traversing the navigation path;
adjusting the navigation path using a discrepancy between real-time RF data and an influence zone of at least one of the RF emitters on the RF landscape map;
at least one of adjusting, refining, or re-evaluating an avoidance strategy;
at least one of adjusting, refining, or re-evaluating the avoidance strategy utilizing non-RF data;
at least one of adjusting, refining, or re-evaluating the avoidance strategy by incorporating a real-time analysis of at least one of RF signal strength variations or potential environmental factors;
continuously comparing real-time RF signal data detected during a flight operation with the RF landscape map to at least one of align a position of an aircraft or adjust a course of the aircraft; or
refining navigation parameters utilizing at least one of a signal strength variation, a signal strength discrepancy, a discrepancy between detected RF emissions and the emission data of the RF landscape map, a positional offset between detected RF emissions and the emission data of the RF landscape map, or a locational offset between detected RF emissions and the emission data of the RF landscape map.

20. The system of claim 14, wherein the memory and the computer program code are configured to, with the at least one processor, further cause the at least one processor to update the RF landscape map at least one of:
utilizing a discrepancy between an expected RF signal characterized in the RF landscape map and a real-time RF signal data detected during a navigation of the navigation path;
by adjusting at least one of a location or a signal characteristic of at least one of the RF emitters to align with newly acquired RF data; or
with acquired data during a flight operation.
